(19) United States
(12) Patent Application Publication
(10) Pub. No.: US 2010/0070288 A1
(43) Pub. Date: Mar. 18, 2010

(54) Method and System for Efficiently Transforming Online Ad Creatives Using Dynamically Compiled Templates

(76) Inventors: Jitendra Nath Pandey, Santa Clara, CA (US); Prabhakar Goyal, Sunnyvale, CA (US); Eyal Arasu Ramakrishnan, Santa Clara, CA (US)

Correspondence Address: Stattler-Suh PC, 60 SOUTH MARKET, SUITE 480, SAN JOSE, CA, 95113, US

(21) Appl. No.: 12/210,962

(22) Filed: Sep. 15, 2008

(51) Int. Cl. G06Q 10/00

(52) U.S. Cl. 705/1

(57) ABSTRACT

A method and system are provided for transforming online ad creatives using dynamically compiled ad templates. In one example, the method includes receiving one or more ad templates into a memory, pre-compiling at least one ad template into object code, converting the object code to a native dynamic library, and loading the native dynamic library into a random access memory.

### FIELD OF THE INVENTION

The present invention relates to online advertising. More particularly, the present invention relates to transforming online ad creatives using dynamically compiled templates.

### BACKGROUND OF THE INVENTION

Electronic ad exchanges, including online auctions and guaranteed deliveries, have proliferated along with the Internet. These electronic exchanges aim to provide a high degree of trading efficiency by bringing together a large number of buyers and sellers. Such exchanges are focused on directly matching the bids and offers of buyers and sellers. Conventional transactions on the exchange are between (i) buyers and sellers, (ii) intermediaries (e.g., brokers, which may be a buyer or seller), or (iii) buyers or sellers and intermediaries.

The proliferation of Internet activity has also generated tremendous growth for advertising on the Internet. Typically, advertisers (i.e., buyers of ad space) and online publishers (sellers of ad space) have agreements with one or more advertising networks (ad networks), which provide for serving an advertiser's banner or ad across multiple publishers, and concomitantly provide for each publisher having access to a large number of advertisers. Ad networks (which may also manage payment and reporting) may also attempt to target certain Internet consumers (i.e., users) with particular advertisements to increase the likelihood that the consumer will take an action with respect to the ad. From an advertiser's perspective, effective targeting is important for achieving a high return on investment (ROI).

Online advertising markets exhibit undesirable inefficiencies when buyers and sellers are unable to transact. For instance, although a publisher may be subscribed to many ad networks, and one or more of those ad networks may transact inventory with other ad networks, only one of the ad networks to which the publisher is subscribed will be involved in selling (e.g., auctioning or guaranteeing delivery) a given ad space for the publisher. The publisher, or a gatekeeper used by the publisher, selects or prioritizes which ad network (or advertiser having a direct agreement with the publisher) will serve the impression for a given ad request.

Further, in online display advertising, advertisers may wish to target broad consumer segments (e.g., California consumers) or specific consumer segments (e.g., males of ages 20-34 in California browsing finance pages). Advertisers need the ability to specify succinctly their values for and exposure (i.e., number of ad views) to various consumer segments, from broad to narrow.

Advertisers spend long hours specifying an ad campaign which, most of the time, ends up not being portable. Once an ad campaign is written down into a contract, a company such as Yahoo!® invests long hours translating the ad campaign into scripts which are used to access the inventory and allocate ads.

Driven by the shift from broadcast to interactive media, almost every aspect of advertising is being automated, including its sale, delivery, and measurement. Moving away from the real estate metaphor of buying space, advertisers may now buy highly specific contextual events like “male user visits sports page on the weekend”, or may buy more general bundles of contextual events. As a result, advertisers need more flexible and expressive ways to describe their ad campaign goals.

In conventional systems, dynamic creation of ads or of content pages requires assembly of dynamic components in near real-time every time a webpage is to be delivery. Separation of ad presentation from content of a webpage is essential in these environments. Ad presentation is typically from the ad design team, whereas content of a webpage may be from various other subsystems. Dynamic data driven ads (e.g., Yahoo!® SmartAds or InfinityAds) are becoming increasingly popular. These types of ads provide more granular targeting by personalizing advertising messages to user interest, location, and other contextual parameters in which the ad are shown. Similarly, dynamic contents from multiple sources form the basic fabric for Web 2.0.

A typical solution is to have templates having tags to indicate the content anchors that need to be substituted or added during webpage delivery time. There are several challenges in putting together this dynamic content, such as the following: dynamic content needs to be assembled during run-time; and assembly of contents include regular expression match (e.g., match ad to consumer searching for “books”), substitutions based on conditions (e.g., if female, then substitute blue background for pink background), substitutions which involve a list of values (e.g., list of ad offers), size based truncations (e.g., substitute ad size 250×50 for 125×50), and string manipulations to the output (e.g., change title from lower case to upper case).

Unfortunately, this process is highly processor intensive on an ad server. The process involves a substantial amount of text processing and takes up most of the processing cycles in delivery of content and ad.

Within this document, one of ordinary skill recognizes certain abbreviations such as, for example, CPI (cost per impression), CPM (cost per 1000 impressions), CPC (cost per click), CPA (cost per acquisition), eCPM (effective CPM).

### SUMMARY OF THE INVENTION

What is needed is an improved method having features for addressing the problems mentioned above and new features not yet discussed. Broadly speaking, the present invention fills these needs by providing a method and system transforming online ad creatives using dynamically compiled ad templates. It should be appreciated that the present invention can be implemented in numerous ways, including as a method, a process, an apparatus, a system or a device. Inventive embodiments of the present invention are summarized below.

In one embodiment, a method is provided for transforming online ad creatives using dynamically compiled ad templates. The method comprises receiving one or more ad templates into a memory, pre-compiling at least one ad template into object code, converting the object code to a native dynamic library, and loading the native dynamic library into a random access memory.

In another embodiment, a template system is provided for transforming online ad creatives using dynamically compiled ad templates. The template system is configured for receiving one or more ad templates into a memory, pre-compiling at least one ad template into object code, converting the object code to a native dynamic library, and loading the native dynamic library into a random access memory.

In still another embodiment, a computer readable medium carrying one or more instructions for transforming online ad creatives using dynamically compiled ad templates is provided. The one or more instructions, when executed by one or more processors, cause the one or more processors to perform the steps of receiving one or more ad templates into a memory, pre-compiling at least one ad template into object code, converting the object code to a native dynamic library, and loading the native dynamic library into a random access memory.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 shows exemplary exchange entities of an ad exchange system, in accordance with an embodiment of the present invention;

FIG. 2A is a block diagram of a system for efficiently transforming online ad creatives using dynamically compiled templates, in accordance with an embodiment of the present invention;

FIG. 2B is a block diagram of the system of FIG. 2A with an exemplary placement of the ad server in an ad exchange system, in accordance with an embodiment of the present invention;

FIG. 3 is an example template that the template system may convert to a native dynamic library, in accordance with an embodiment of the present invention; and

FIG. 4 is a flowchart of a method for efficiently transforming online ad creatives using dynamically compiled templates, in accordance with an embodiment of the present invention.

### DETAILED DESCRIPTION OF THE INVENTION

An invention for a method and system for transforming online ad creatives using dynamically compiled ad templates is disclosed. Numerous specific details are set forth in order to provide a thorough understanding of the present invention. It will be understood, however, to one skilled in the art, that the present invention may be practiced with other specific details.

### Overview of System

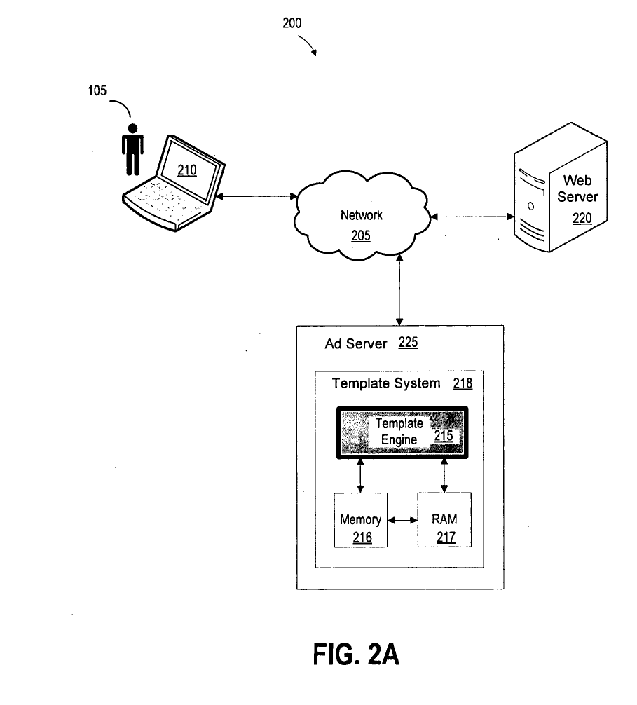

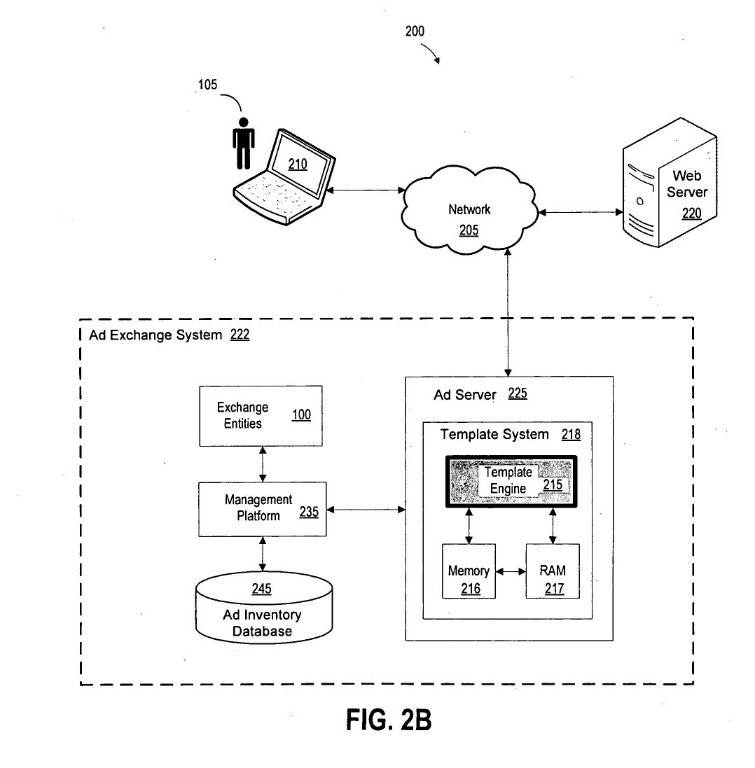

FIG. 2A is a block diagram of a system 200 for efficiently transforming online ad creatives using dynamically compiled templates, in accordance with an embodiment of the present invention. A device of the present invention is hardware, software or a combination thereof. A device may sometimes be referred to as an apparatus or a system. Each device is configured to carry out one or more steps of the method of efficiently transforming online ad creatives using dynamically compiled templates.

A network 205 couples together a consumer computer 210, a web server 220 and an ad server 225. The network 205 may be any combination of networks, including without limitation the Internet, a local area network, a wide area network, a wireless network and a cellular network. Devices of the ad server 225 include without limitation a template system 218. Devices of the template system 218 include without limitation a template engine 215, memory 216 and RAM 217, which are coupled to one another. The memory 216 may be any form of non-volatile memory, such as a hard disk. The RAM 217 may be any form of random access memory or, more broadly, any form of memory that allows access in any order. The template engine 216 carries out the more important operations of the template system 218. In another embodiment, the template system 218 may be located on an application server (not shown), or on another suitable computing device, that is coupled to the network 205.

The template system 218 is any combination of software and/or hardware used to help produce a webpage using the template engine 215 and to deploy the webpage to a consumer computer 210. The template engine 215 is any combination of software and/or hardware that carries out the more important operations within the template system 218. The template engine 215 is configured for processing web templates, ads and content information to produce the web page.

The template system 218 substantially alleviates the processing strain on a computing apparatus, such as the ad server 225, running the template engine 215. The template system 218 assembles templates for ads and content (e.g., the other data on a webpage besides ads). The template system 218 is highly configurable, via the templates, and allows the computing apparatus hosting the templates to utilize the templates at compiled code speed.

A user (e.g., ad designer) may access the template system 218 via a client computer (not shown) that is coupled to the network 205. The client computer may be, for example, a desktop computer, a laptop computer, a workstation, a smart phone, a cell phone, or a mobile computing device, among other things.

In some embodiments, the ad server 225 may run the template engine 215 while offline. Once the ad server 225 is online again, the ad server 225 may carry out appropriate online tasks. The template engine 215 may reside on one computing apparatus or any combination of computing apparatuses, including without limitation the ad server 225, the web server 220, a client computer (not shown), an application server (not shown) or any other appropriate platform.

Template System with Respect to Ad Exchange System

In some embodiments, the template system 218 operates in the context of an ad exchange system. Provided here is a description of exchange entities of an ad exchange system. Then, a description of the template system 218 within the context of the ad exchange system is provided.

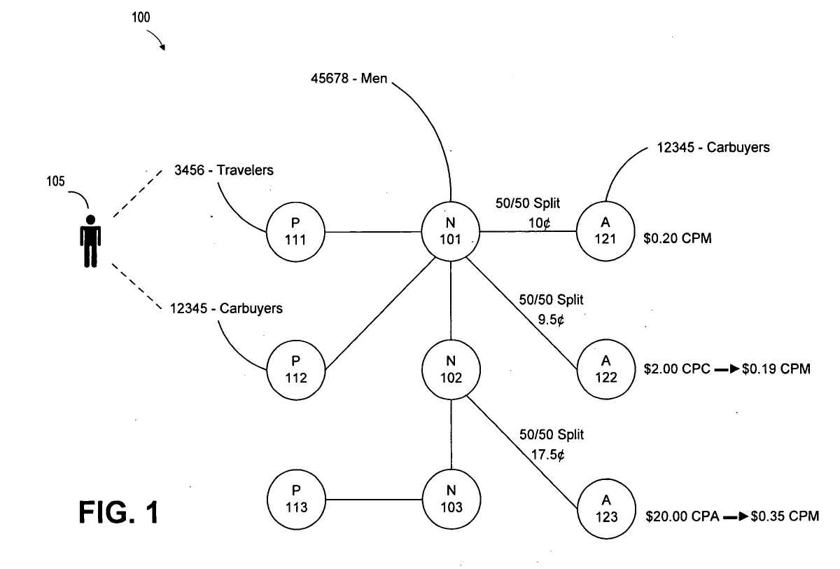

FIG. 1 shows exemplary exchange entities 100 of an ad exchange system, in accordance with an embodiment of the present invention. The exchange entities 100 include ad networks 101, 102, 103, publishers 111, 112, 113, and advertisers 121, 122, 123. Examples of an ad network include Yahoo!® Ad Network and MediaNews Group®. One of ordinary skill recognizes that the foregoing entities are exemplary and that the exchange entities 100 may contain other ad networks, publishers, advertisers, and/or other entities.

The publishers 111, 112, 113 preferably have content that is of interest to consumers 105 of such content. For instance, the publisher 112 may have a web page such as Edmunds.com that is directed to car buyers. Consumers 105 on the Internet may visit the web page to obtain the content provided. Some embodiments log the visits and/or activities of the consumers 105 on the web page, and further generate segments of consumers 105 who interact with the content. As shown in the figure, the publisher 111 may have content for travelers, while the publisher 112 has content for car buyers. Each segment preferably has a unique identifier that is unique to the segment, and is also unique to the entity. In this example, the segment “Car Buyers” for the publisher 112 is assigned the identifier “12345,” the segment “Travelers” for the publisher 111 is assigned the identifier “3456,” and the segment “Men” is assigned the identifier “45678” for the ad network 101.

As consumers 105 and/or segments of consumers 105 interact with the content provided by the publishers 111, 112, 113, “ad calls” are generated for the publishers' advertising inventory. Generally, in non-guaranteed delivery, the advertisers 121, 122, 123, bid to supply advertising to the available inventory. In this example, the advertiser 121 bids $0.20 CPM, the advertiser 122 bids $2.00 CPC, and the advertiser 123 bids $20.00 CPA. Some systems normalize the bids and/or costs to CPM. Hence, the $2.00 CPC may be normalized to $0.19 CPM, and the $20.00 CPA to $0.35 CPM. Further, the advertisers 121, 122, 123 may have split fee arrangements with the ad networks 101, 102, 103. FIG. 1 illustrates 50/50 split fee arrangements between each advertiser 121, 122, 123, and each ad network 101, 102, 103. More specifically, for the $0.20 CPM the advertiser 121 pays for presentation of its advertising to consumers 105, the advertiser pays $0.10 CPM to the ad network 101. Other fee arrangements, however, are recognized by one of ordinary skill.

The advertisers 121, 122, 123 typically have advertising campaigns that include one or more ad creatives that promote a particular brand or product. The advertisers 121, 122, 123 may wish to specify certain criteria for each campaign such as, for example, maximum spend per day on the delivery of advertising, and/or criteria for targeted advertising. Examples of “hard targeting” include directing an advertisement to a particular gender and/or during a particular time of day. The advertisers 121, 122, 123 may further target particular consumers 105 and/or segments of consumers 105. Particular transactions and/or data have additional value for the exchange entities 100. For instance, one or more ads and/or campaigns for the advertiser 121 may have particular relevance to the Car buyers 12345.

In one implementation, an ad manager server maintains a history of attributes for several advertisements, and predicts the value per advertisement in relation to each publisher. The ad server may perform the foregoing alternatively, or in conjunction with, behavioral type targeting based on consumer data. In some of these embodiments, each consumer 105 has a cookie space that is used by various entities to store information. For instance, one or more entities of the exchange entities 100 advantageously write into a consumer's cookie space an integer identifier that corresponds to a particular consumer segment.

The exchange entities 100 include advertisers that want to advertise with a publisher. An ad network (e.g., Yahoo!® Ad Network) in the exchange entities 100 is authorized to deal and establish contracts on behalf of the advertiser. Another ad network (e.g., MediaNews Group®) is authorized to deal and establish contracts on behalf of the publisher. As discussed above, there may be any number of entities between the outer entities, the advertiser 121 and the publisher 113.

FIG. 2B is a block diagram of the system 200 of FIG. 2A with an exemplary placement of the ad server 225 in an ad exchange system 222, in accordance with an embodiment of the present invention. For explanatory purposes, the template system 218 is located in the ad server 225 of the ad exchange system 222. However, as discussed above with reference to FIG. 2A, the template system 218 may be loaded on one computing apparatus or a combination of computing apparatuses.

The network 205 couples together a consumer computer 210, a web server 220 and an ad exchange system 222. The ad exchange system 222 includes without limitation the ad server 225 (or ad server system), exchange entities 100 of FIG. 1, a management platform 235, and an ad inventory database 245. Devices of the ad server 225 include without limitation a template system 218. Devices of the template system 218 include without limitation a template engine 215, memory 216 and RAM 217, which are coupled to one another. A user (e.g., ad designer) may access the template system 218 through a user interface (not shown). The ad server 225 is coupled to the management platform 235. The management platform is coupled to the exchange entities 100 and the ad inventory database 245.

After the management platform 235 receives data objects of an ad campaign, the management platform 235 translates (i.e., compiles) the data objects into scripts (i.e., common data structures). The management platform 235 uses the scripts to access inventory from the ad inventory database 245, to update budgets and to update statistics of impressions (i.e., views of an advertisement), among other things. The management platform 235 sends algorithms for ad pricing and ad allocation to the ad server 225.

### Methodology of Template System

Referring to FIG. 2A, the template system 218 allows a user (e.g., ad designer) to utilize a template to specify how the user would like to use an ad creative. The templates are written in a rich dynamic language with constructs. The constructs allow the user to express listings, loops, conditions, variables for an ad. The template engine 215 on startup reads the configured templates located in memory 216. The template engine 215 converts the templates to binary code as a dynamic loadable library. In other words, the template engine 215 converts and optimizes all the templates on the fly into native machine code (i.e., binary code). The converted templates are then ready for machine execution.

The converting process is described here with more detail. A user (e.g., ad designer) writes a template as a guide for the ad server on how the user would like to mix and match content and ad presentation. Ad presentation is the set of parameters that define how a user would like a particular ad to appear on a webpage. Ad presentation is typically dependent on characteristics of the particular consumer browsing the webpage. Ad presentation allows an ad server to ask the creative deliver subsystem (not shown) to personalize an ad based on characteristics of the particular consumer. For example, if the ad server 225 determines the consumer is male, the ad presentation may indicate the ad is to have a blue background color; however, if the ad server 225 determines the consumer is female, the ad presentation may indicate the ad is to have a pink background color. When the ad is called, the ad server 225 sends a request to the creative delivery subsystem to display the ad according to the ad presentation parameters.

Content data of a webpage typically come from a different location than ad presentation. Ad presentation is typically from an ad design team, whereas content of a webpage may be from various other subsystems. A template is typically written as a hash table, xml (extensible markup language) or java script. Different users may use different languages to write a template.

One purpose of the template engine 215 is to apply processing to the templates to standardize the templates internally for the template engine 215. In a first pass of the converting process, the template engine 215 pre-compiles each template. The pre-compiling involves applying optimizations to each template and performing any necessary string manipulations on the templates. The template engine 215 includes a parser (not shown) that parses the template to convert the template language to analogous object code. In a second pass of the converting process, the template engine 215 converts the object code to a native dynamic library. The native dynamic library is machine readable binary code. The native dynamic library is then loaded into RAM 217 and ready for execution by the ad server 225.

In an alternative embodiment, the template system 218 carries out the template converting process dynamically during runtime the first time a particular ad is called. The native dynamic library is then loaded into RAM 217 and ready for execution by the ad server 225 for that ad call and for future ad calls.

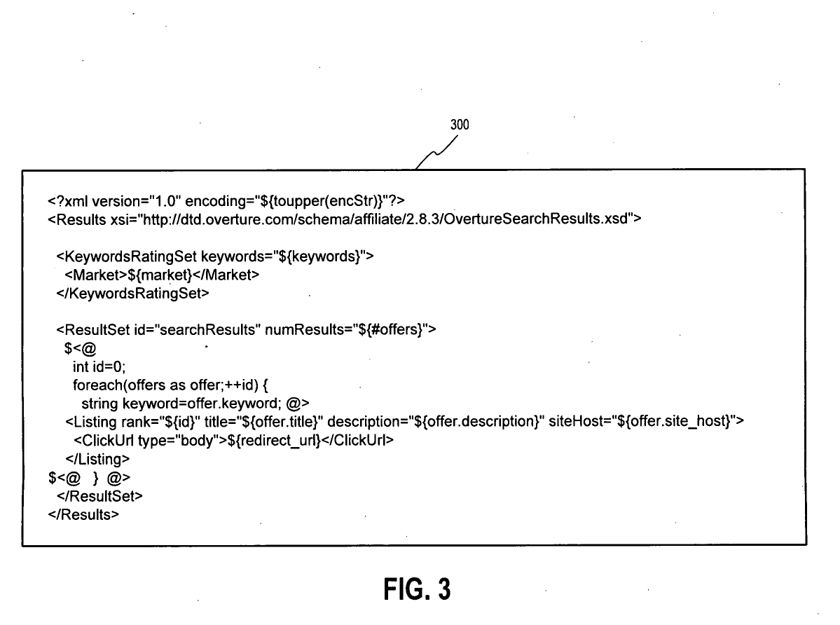

FIG. 3 is an example template 300 that the template system may convert to a native dynamic library, in accordance with an embodiment of the present invention. This example template 300 is written in xml. As an example of the converting process, the template engine will pre-compile the “foreach” loop and then convert the resulting object code to a native dynamic library. The native dynamic library is then loaded into RAM and ready for execution by the ad server.

After load time, all the requests (e.g., ad call or offer) to the template engine will be resolved to variable references and function calls within the native dynamic library. The ad server 225 thereby achieves significantly improved performance goals that are more desirable than the ad server operating without the native dynamic library. During this phase after load time, there are no regular expression matches or interpretation of the templates because the template is already in the form of executable code. The template system thereby boosts the overall performance of the ad server or any other computing system hosting the template system.

### Method Outline

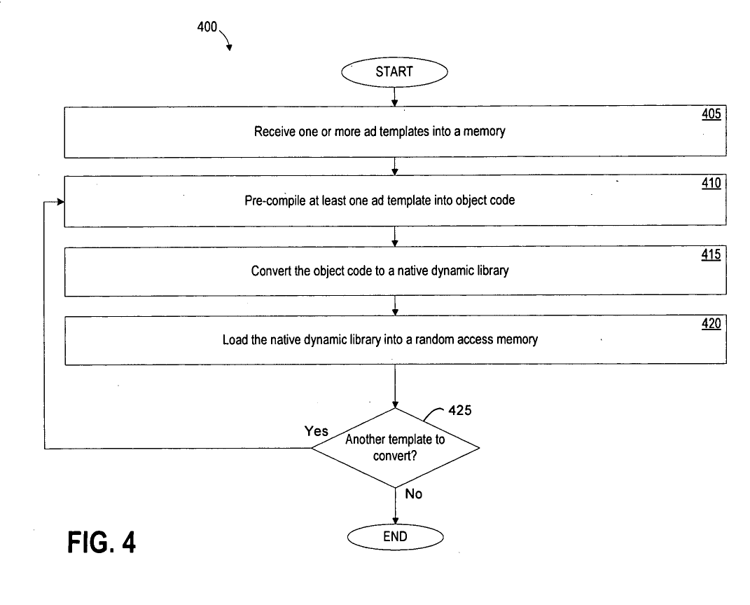

FIG. 4 is a flowchart of a method 400 for efficiently transforming online ad creatives using dynamically compiled templates, in accordance with an embodiment of the present invention. The steps of the method 400 may be carried out by the template system 218 of FIGS. 2A and 2B. The method 400 starts in step 405 where the system receives one or more templates into a memory. The system and the memory preferably reside on an ad server. The method 400 then moves to step 410 where the system pre-compiles at least one template into object code. Next, in step 415, the system converts the object code to a native dynamic library. The method 400 then proceeds to step 420 where the system loads the native dynamic library into a random access memory of the system. Next, in decision operation 425, the system determines if there is another template to convert. If there is at least one other template to convert, the system returns to step 410 and continues. However, if there is no other template to convert, the method is at an end.

Additional steps of the method may include without limitation receiving an ad call into the template system, accessing one or more variables of the native dynamic library, and initiating one or more function calls of the native dynamic library, among other steps.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include without limitation any type of disk including floppy disks, mini disks (MD's), optical disks, DVDs, CD-ROMs, micro-drives, and magneto-optical disks, ROMS, RAMs, EPROMS, EEPROMS, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include without limitation device drivers, operating systems, and user applications. Ultimately, such computer readable media further includes software for performing the present invention, as described above.

Included in the programming (software) of the general/specialized computer or microprocessor are software modules for implementing the teachings of the present invention, including without limitation receiving one or more ad templates into a memory, pre-compiling at least one ad template into object code, converting the object code to a native dynamic library, and loading the native dynamic library into a random access memory, according to processes of the present invention.

### Advantages

Configurability and performance are the two key advantages in this scheme. A user (e.g., ad designer) can readily configure templates for use in the template system. A template compiled to the native dynamic library substantially increases processing performance with respect to the template system.

The user still maintains templates because the template system supports separation of the ad server's application code from the native dynamic library. The native dynamic library is flexible and maintainable via a template, which is accessible to a user.

Performance of the template engine is native. There are no subsequent parsing (or interpretation) overheads like in traditional template engine code. Once a template is parsed and compiled for the first time, that converted template is native dynamic code and machine executable for future ad calls.

Further, all the standard template engine advantages still apply. Users cannot break code of the software applications on the ad server. Users can do damage to the templates. However, the ad server's application code stays intact. The ad server still runs even if a template or a native dynamic library has an error. Accordingly, the application code is tighter, more secure and easier to maintain.

Another standard advantage is that errors in the templates are confined to the template engine's error handling routines. Such confinement makes the errors remarkably simple and intuitive for the user to analyze.

Still another standard advantage is that a template is a close representation of what the final output will be for that template. This close representation provides a user-friendly, intuitive approach for users to design templates with confidence.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for transforming online ad creatives using dynamically compiled ad templates, the method comprising:
receiving one or more ad templates into a memory;
pre-compiling at least one ad template into object code;
converting the object code to a native dynamic library; and
loading the native dynamic library into a random access memory.

2. The method of claim 1, further comprising:
receiving an ad call;
accessing one or more variables of the native dynamic library; and
initiating one or more function calls of the native dynamic library.

3. The method of claim 1, wherein the ad template is a script that functions as a guide for how a user would like to mix and match various content and an ad presentation.

4. The method of claim 1, wherein the pre-compiling comprises:
applying optimizations to the at least one template; and
performing any necessary string manipulations on the at least one template.

5. The method of claim 1, wherein the pre-compiling comprises parsing the at least one template to convert the at least one template to analogous object code.

6. The method of claim 1, wherein the converting the object code to a native dynamic library comprises converting the object code to machine readable binary code.

7. The method of claim 1, wherein the pre-compiling and the converting are carried out substantially immediately upon starting up a template engine configured for carrying out the method.

8. The method of claim 1, wherein the pre-compiling and the converting are carried out during runtime after a particular ad is called.

9. The method of claim 2, wherein there are no regular expression matches of the at least one template and no interpretations of the at least one template.

10. The method of claim 1, wherein an ad server hosts the native dynamic library and application code, wherein the native dynamic library is flexible and separate from the application code of the ad server.

11. A template system for transforming online ad creatives using dynamically compiled ad templates, the template system is configured for:
receiving one or more ad templates into a memory;
pre-compiling at least one ad template into object code;
converting the object code to a native dynamic library; and
loading the native dynamic library into a random access memory.

12. The template system of claim 11, wherein the template system is further configured for:
receiving an ad call;
accessing one or more variables of the native dynamic library; and
initiating one or more function calls of the native dynamic library.

13. The template system of claim 11, wherein the ad template is a script that functions as a guide for how a user would like to mix and match various content and an ad presentation.

14. The template system of claim 11, wherein the pre-compiling further configures the template system for:
applying optimizations to the at least one template; and
performing any necessary string manipulations on the at least one template.

15. The template system of claim 11, wherein the pre-compiling further configures the template system for parsing the at least one template to convert the at least one template to analogous object code.

16. The template system of claim 11, wherein the converting the object code to a native dynamic library further configures the template system for converting the object code to machine readable binary code.

17. The template system of claim 11, wherein the template system is further configured for carrying out the pre-compiling and the converting substantially immediately upon starting up a template engine configured for carrying out the method of the template system.

18. The template system of claim 11, wherein the template system is further configured for carrying out the pre-compiling and the converting during runtime after a particular ad is called.

19. The template system of claim 12, wherein there are no regular expression matches of the at least one template and no interpretations of the at least one template.

20. The template system of claim 11, wherein an ad server hosts the native dynamic library and application code, wherein the native dynamic library is flexible and separate from the application code of the ad server.

21. A computer readable medium carrying one or more instructions for transforming online ad creatives using dynamically compiled ad templates, wherein the one or more instructions, when executed by one or more processors, cause the one or more processors to perform the steps of:
receiving one or more ad templates into a memory;
pre-compiling at least one ad template into object code;
converting the object code to a native dynamic library; and
loading the native dynamic library into a random access memory.
